(19) United States
(12) Patent Application Publication
(10) Pub. No.: US 2026/0349911 A1
(43) Pub. Date: Nov. 5, 2026

(54) INTEGRATED CIRCUIT DEVICE DATA PATH TESTING FOR FUNCTIONAL SAFETY

(71) Applicant: Xilinx, Inc., San Jose, CA (US)

(72) Inventors: Naresh Nagula, Vasanth Nagar Colony (IN); Mohan Marutirao Dhanawade, Durganagar Colony (IN); Saraschandra Reddy Madem, Narsingi (IN); Priyanka Pandey, Haldwani (IN); Mukund Sivaraman, Palo Alto, CA (US); Sharat Babu Kotamraju, Hyderabad (IN); Vijaya Raghava Chiyedu, Hyderabad (IN)

(73) Assignee: Xilinx, Inc., San Jose, CA (US)

(21) Appl. No.: 19/194,531

(22) Filed: Apr. 30, 2025

(51) Int. Cl. G06F 11/3668

(52) U.S. Cl. CPC G06F 11/3696

(57) ABSTRACT

Testing data paths of an integrated circuit device includes detecting data flows between a subset of compute tiles of a plurality of compute tiles of a data processing array that implement an application. Dependencies between input interfaces and output interfaces of the subset of compute tiles that implement the data flows within the data processing array are detected. An ordered list of data transfer operations performed by the subset of compute tiles is generated on a per-compute tile basis based on the data flows and the dependencies. For each compute tile of the subset of compute tiles, an input/output software test (IO-ST) kernel configured to execute the ordered list of data transfer operations for the compute tile is generated. The IO-ST kernel mimics read operations and write operations of one or more application kernels of the application mapped to the compute tile.

### TECHNICAL FIELD

This disclosure relates to integrated circuit (IC) devices and, more particularly, to testing data paths of IC devices that include data processing arrays for functional safety.

### BACKGROUND

Integrated circuits (IC) devices have evolved over time to provide increasingly sophisticated computing architectures. While some IC devices utilize computing architectures that include a single processor, others include multiple processors. Still, other IC devices include multiple processors arranged in an array. Such IC devices are capable of providing significant computational power and a high degree of parallelism that extends well beyond the capabilities of single-processor architectures and even multi-core processor architectures.

Functional safety is an engineering design process that seeks to add or include mechanisms within systems that provide automatic protection. Functional safety helps to protect people from unacceptable risk of injury or damage to health from faults that may occur within systems and/or equipment by way of implementing one or more automatic safety functions. Industries of all varieties, whether consumer appliances, automotive, robotics, medical, or aerospace, for example, build systems with functional safety in mind. Types of faults that functional safety may protect against can include those induced during operation of a system by temperature extremes, cosmic radiation, or the like. Examples of hardware-based functional safety techniques include, but are not limited to, lockstep processor operation, triple modular redundancy (TMR), error correcting codes (ECCs), parity bits, or the like.

Because of performance requirements, area constraints, and/or power constraints, the use of hardware-based functional safety solutions may be limited. In such cases, software-based functional safety solutions may be added to a system and be used in place of and/or in addition to hardware-based functional safety solutions.

### SUMMARY

In one or more examples, a method includes detecting data flows between a subset of compute tiles of a plurality of compute tiles of a data processing array that implement an application. The method includes detecting dependencies between input interfaces and output interfaces of the subset of compute tiles that implement the data flows within the data processing array. The method includes generating an ordered list of data transfer operations performed by the subset of compute tiles on a per-compute tile basis based on the data flows and the dependencies. The method includes, for each compute tile of the subset of compute tiles, generating an input/output software test (IO-ST) kernel configured to execute the ordered list of data transfer operations for the compute tile. The IO-ST kernel mimics read operations and write operations of one or more application kernels of the application mapped to the compute tile.

In one or more examples, a method includes loading a data path configuration of an application into a data processing array having a plurality of compute tiles. The application uses a subset of the plurality of compute tiles and the data path configuration implements data paths for the application among the subset of compute tiles. The method includes testing the data paths of the application within the data processing array by loading and executing IO-ST kernels into the subset of compute tiles. The data paths are a subset of available data paths of the data processing array used by the application. The method includes loading and executing application kernels into the subset of compute tiles.

In one or more examples, an integrated circuit device includes a data processing array having a plurality of compute tiles. Each compute tile includes a plurality of interfaces. A subset of compute tiles of the plurality of compute tiles are selected to implement an application. The data processing array implements data paths of the application between the subset of compute tiles using selected interfaces of the plurality of interfaces of the subset of compute tiles. The subset of compute tiles alternatingly implement the application having one or more application kernels mapped to the subset of compute tiles and IO-ST kernels mapped to the subset of compute tiles to perform functional safety testing of the data paths of the application.

This Summary section is provided merely to introduce certain concepts and not to identify any key or essential features of the claimed subject matter. Many other features and implementations of the disclosed technology will be apparent from the accompanying drawings and from the following detailed description.

### BRIEF DESCRIPTION OF THE DRAWINGS

The accompanying drawings show one or more implementations of the disclosed technology. The drawings, however, should not be construed to be limiting of the implementations to only the examples shown. Various aspects and advantages will become apparent upon review of the following detailed description and upon reference to the drawings.

FIG. 1 illustrates an example implementation of an integrated circuit (IC) device.

FIG. 2 illustrates a portion of the data processing array of FIG. 1 in greater detail.

FIG. 3 illustrates an example of a functional safety framework capable of generating a functional safety testing application for a data processing array.

FIG. 4 illustrates an example method of generating a functional safety testing application as performed by the functional safety framework of FIG. 3.

FIG. 5 illustrates an example of a deadlock condition that may occur in a data processing array due to input/output software-test (IO-ST) kernels mimicking data transfer operations of an application in a deadlock inducing order.

FIG. 6 illustrates a different ordering of the mimicked data transfer operations for the IO-ST kernels that avoids the deadlock condition.

FIG. 7 illustrates an example method of implementing certain operations of FIG. 4.

FIG. 8 illustrates an example method of performing functional safety testing of data paths of a data processing array.

FIG. 9 illustrates an example timing diagram for performing functional safety testing of data paths of a data processing array.

FIG. 10 illustrates an example state of a data processing array executing a user application.

FIG. 11 illustrates an example state of the data processing array executing a functional safety testing application.

FIG. 12 illustrates an example of a data processing system capable of executing a functional safety framework as described within this disclosure.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuit (IC) devices and, more particularly, to testing data paths of IC devices for functional safety. Different industries may set their own standards for functional safety certification. An example of this is ISO Standard 26262 which defines a risk classification scheme for functional safety known as “Automotive Safety Integrity Level” or “ASIL.” Different levels of risk under ASIL, moving from low risk to high risk, are A, B, C, and D. The example implementations described herein provide frameworks for software-based functional safety testing of data paths of an IC device. The example implementations may be used to meet any of a variety of different functional safety standards including, but not limited to, those of ASIL.

Some IC devices include a large number of processing units. An example of such an IC device is one that includes a data processing array. An example of a data processing array is a neural processing unit or “NPU.” The data processing array includes a large number of different data paths that may be created and/or used within the IC device. These data paths connect or link the different processing units of the data processing array allowing them to communicate and exchange data while executing an application. A large and complex data processing array may include hundreds of processing units each having a plurality of different interfaces. Testing all possible permutations and combinations of interfaces requires testing an inordinate number of data paths. Testing all possible data paths of the data processing array requires significant time and may cause the data processing array to spend more time executing tests than running a user application.

In one or more examples, methods and systems (e.g., IC devices) are provided that are capable of implementing software-based functional safety frameworks capable of performing functional testing on data paths of an IC device. Rather than attempting to test each data path that is available on the IC device, the example implementations described within this disclosure detect only those data paths within the IC device that are used by a user application. This means that only a subset of the total data paths available in the IC device are subject to functional safety testing.

The example implementations may not only be executed in significantly less time than other software-based approaches that seek to test all available data paths, but the IC device itself may be configured in less time. The reduced configuration time means that the IC device may be reconfigured between the user application and the testing application to perform functional safety testing from time-to-time or periodically during runtime without sacrificing too much runtime of the user application. That is, the amount of time needed to reconfigure the IC device to perform functional safety testing of the data paths and the time needed to perform functional safety testing of the data paths once configured is reduced thereby leaving more time for the user application to execute.

Further aspects of the disclosed technology are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

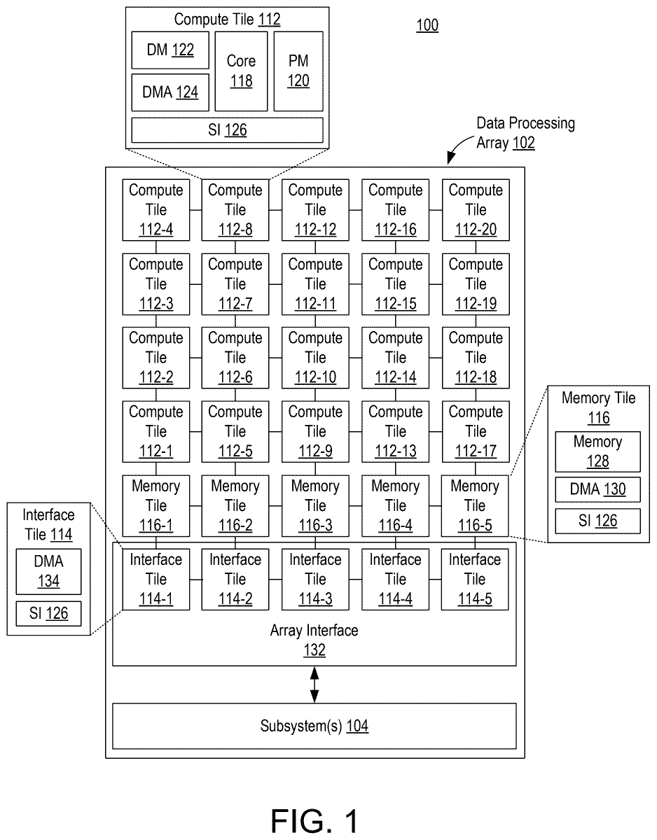

FIG. 1 illustrates an example implementation of an IC device 100. IC device 100 includes a data processing array 102. Data processing array 102 is an example of a neural processing unit (NPU). In the example, data processing array 102 is coupled to one or more other subsystems 104. Examples of subsystems 104 may include, but are not limited to, a network-on-chip, a processor system including one or more hardened processor and/or processor cores, programmable logic, input/output interfaces, transceivers, or the like, other Application-Specific IC (ASIC) blocks, and/or any combination thereof.

In the example, data processing array 102 is implemented as a plurality of interconnected tiles. The term “tile,” as used herein in connection with a data processing array or NPU, refers to a circuit block. The interconnected tiles of data processing array 102 include compute tiles 112, interface tiles 114, and optionally memory tiles 116. The tiles illustrated in FIG. 1 may be arranged in an array or grid and are hardwired.

Each compute tile 112 can include one or more cores 118, a program memory (PM) 120, a data memory (DM) 122, a direct memory access (DMA) circuit 124, and a stream interconnect (SI) 126. In one aspect, each core 118 is capable of executing program code, e.g., one or more kernels, stored in program memory 120. In one aspect, each core 118 may be implemented as a scalar processor, as a vector processor, or as a scalar processor and a vector processor operating in coordination with one another.

In one or more examples, each core 118 is capable of directly (via memory interfaces independent of stream interconnect 126 and/or DMA circuit 124) accessing the data memory 122 within the same compute tile 112 and the data memory 122 of any other compute tile 112 that is adjacent to the core 118 of the compute tile 112 in the up (north), down (south), left (west), and/or right (east) directions. Core 118 sees data memories 122 within the same tile and in one or more other adjacent compute tiles as a unified region of memory (e.g., as a part of the local memory of the core 118). This facilitates data sharing among different compute tiles 112 in data processing array 102.

Cores 118 may be directly connected with adjacent cores 118 via core-to-core connections referred to as cascade connections (not shown). In one aspect, cascade connections are unidirectional and direct connections between cores 118. In another aspect, cascade connections are bidirectional and direct connections between cores 118. In general, cascade connections allow the results stored in an accumulation register of a source core 118 to be provided directly to an input of a target or load core 118. This means that data provided over a cascade connection may be provided among cores directly with less latency since the data does not traverse the stream interconnect 126 and is not written by a first core 118 to data memory 122 to be read by a different core 118.

In an example implementation, compute tiles 112 do not include cache memories. By omitting cache memories, data processing array 102 is capable of achieving predictable, e.g., deterministic, performance. Further, significant processing overhead is avoided since maintaining coherency among cache memories located in different compute tiles 112 is not required. In a further example, cores 118 do not have input interrupts. Thus, cores 118 are capable of operating uninterrupted. Omitting input interrupts to cores 118 also allows data processing array 102 to achieve predictable, e.g., deterministic, performance.

In the example of FIG. 1, each compute tile 112 may be implemented substantially identically to include the same hardware components and/or circuitry. Further, data processing array 102 may include an array of compute tiles formed of any of a variety of processing elements such as digital signal processing engines, cryptographic engines, Forward Error Correction (FEC) engines, or other specialized hardware for performing one or more specialized tasks.

In one or more other examples, compute tiles 112 may not be substantially identical. In this regard, compute tiles 112 may include a heterogeneous mix of compute tiles 112 such that data processing array 102 includes different types of compute tiles where each type of compute tile uses a different type of processing element. As an illustrative and nonlimiting example, different ones of compute tiles 112 may include processing elements selected from two or more of the following groups: digital signal processing engines, cryptographic engines, Forward Error Correction (FEC) engines, or other specialized hardware.

In the example of FIG. 1, data processing array 102 includes one or more memory tiles 116. In some examples, memory tiles 116 may be omitted from data processing array 102. Memory tiles 116 include a memory 128 (e.g., a RAM), a DMA circuit 130, and a stream interconnect 126. Each memory tile 116 may read and/or write to the memory 128 therein and/or to an adjacent memory tile 116 by way of the DMA circuit 130 and stream interconnect 126 included in the memory tile 116. Further, data can be moved to/from the data memory 122 of any compute tile 112 (e.g., by the corresponding DMA circuit 124) from/to the memory 128 of any memory tile 116 (e.g., by the corresponding DMA circuit 130 or the DMA circuit 130 of an adjacent memory tile 116). In doing so, the data is routed through one or more of stream interconnects 126. Memory tiles 116 are characterized by the lack of computational components such as processors (e.g., cores 118). In the example of FIG. 1, each memory tile 116 may be implemented substantially identically to include the same hardware components and/or circuitry. In one or more other examples, memory tiles 116 may not be identical.

Interface tiles 114 form an array interface 132 for data processing array 102. Array interface 132 operates as an interface that connects tiles of data processing array 102 to other resources, e.g., subsystem(s) 104, of IC device 100. In the example of FIG. 1, array interface 132 includes a plurality of interface tiles 114 organized in a row. Interface tiles 114 can include a stream interconnect 126 and a DMA circuit 134. Interface tiles 114 are connected so that data may be propagated from one interface tile 114 to another bi-directionally. Each interface tile 114 is capable of operating as an interface for the column of tiles directly above and is capable of interfacing such tiles with components and/or subsystems of IC device 100.

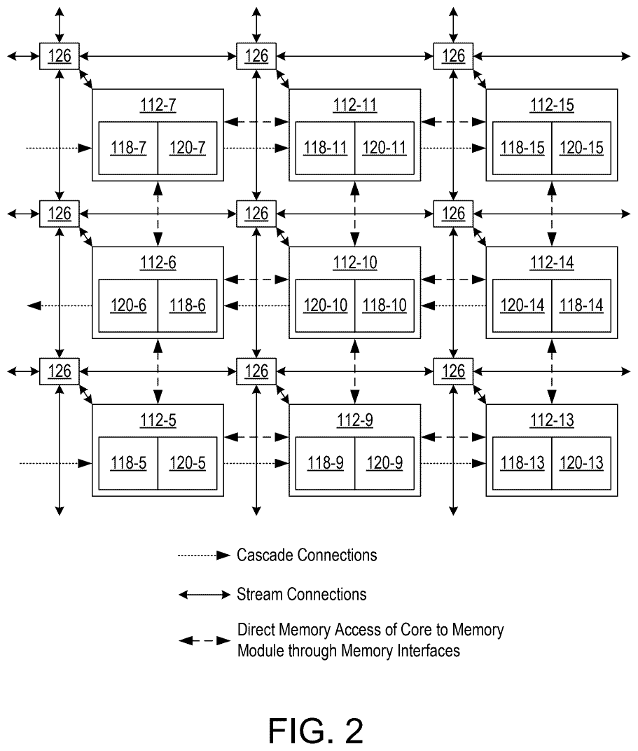

The example of FIG. 1 illustrates multiple different ways that the tiles of data processing array 102 are capable of communicating. These different data paths and the interfaces that implement the data paths are discussed in greater detail in connection with FIG. 2.

FIG. 2 illustrates a portion of data processing array 102 in greater detail. The example of FIG. 2 illustrates different data paths that exist between different of ones of compute tiles 112. As illustrated, compute tiles 112 may communicate over data paths that include cascade connections, by direct memory access through memory interfaces of data memories by cores 118 (e.g., shared memory), and/or by stream connections through stream interconnects 126. Though not illustrated, cascade connections may connect adjacent rows of compute tiles 112. Direct memory access may refer to a core such as core 118-10 access memory module 120-10 in the same compute tile (e.g., in compute tile 112-10) or a memory module of an adjacent compute tile such one or more of compute tiles 112-14, 112-11, and/or 112-9. The stream connections utilize DMA circuits 124 in the respective compute tiles 112 to access data memories 122 within compute tiles 112.

Each of these different data paths may be used independently of the others. That is, a given compute tile 112 may communicate with one or more other compute tiles 112 using one or more or all of the aforementioned data paths and corresponding interfaces. Appreciably, communication using stream interconnects allows two compute tiles 112 that are not adjacent to communicate. More particularly, a compute tile 112 may communicate with another compute tile despite the two compute tiles being separated by one or more intervening compute tiles.

In an actual data processing array 102, there may be significantly more tiles, including compute tiles, than illustrated in FIG. 1 and/or FIG. 2. In some cases, data processing array 102 may include hundreds of tiles and/or compute tiles. In such cases, it may be appreciated that the number of data paths available, particularly since compute tiles may communicate with non-adjacent compute tiles, is significant.

Applications that are implemented in data processing array 102 are typically specified as a data flow graph (DFG). A DFG is a collection of edges and nodes in which the nodes represent functions implemented as kernels and the edges connect the nodes and represent data flows (e.g., data transfer operations). The kernels may be implemented as compiled program code that is executable by the cores 118. The compilation process further maps the respective executable versions of the kernels to different compute tiles 112. The edges are mapped to particular data paths and corresponding interfaces. More than one kernel may be mapped to a single compute tile 112 and executed by the core 118 therein.

As part of the compilation process, configuration data, referred to herein as a data path configuration, is generated that configures components within data processing array 102. Components such as stream interconnect 126, DMA circuits 124, 130, and/or 134, and/or cascade connections may be programmed or configured with a data path configuration to establish or implement particular data paths. Typically, an application that is compiled to run on data processing array 102 does not utilize all available tiles. The application often uses a subset of the tiles of data processing array 102 (i.e., fewer than all of the available tiles or compute tiles as the case may be). In other words, while the available data paths of data processing array 102 allow any tile to communicate with any other tile, the application ultimately defines which data paths are used. Not all data paths available within data processing array 102 will be used by a given application. From a functional safety point of view, only those data paths actually used by an application need be tested to achieve a given level of functional safety at least with respect to data paths of data processing array 102.

For instance, in typical data processing array 102 data flows, there are hundreds of stream interfaces, multiple DMA channels for each DMA circuit, interfaces to other subsystems such as programmable logic, and memory lock resources that may be shared across all tiles of the array. Usage of such resources for a given application may not exceed 50%. The actual data paths used by an application may vary from case to case depending on the placement and routing optimizations performed while compiling the application. If a common solution for all applications is to test all data paths, as noted, more clock cycles would be spent testing data paths including data paths not used by the application than actually running the user application.

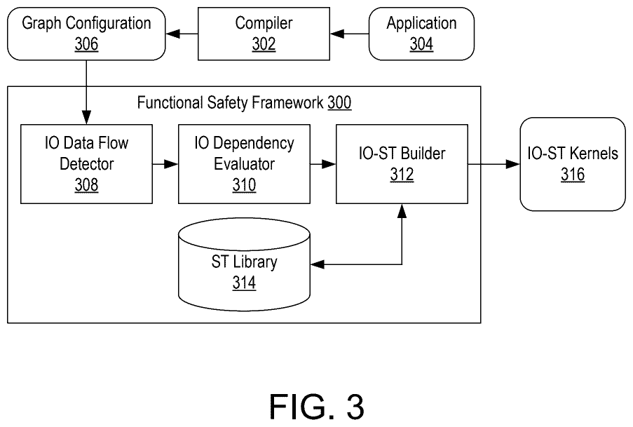

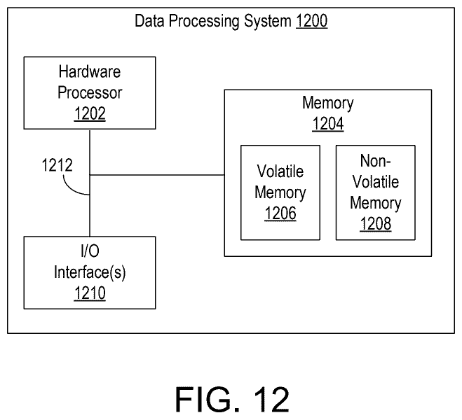

FIG. 3 illustrates an example of a functional safety framework (framework) 300 that is capable of generating a functional safety testing application for data processing array 102. Framework 300 is executable by a data processing system, e.g., a computer. An example of a data processing system that is capable of executing framework 300 is illustrated in FIG. 12.

In the example of FIG. 3, a compiler 302 is capable of compiling an application 304. Application 304 is an example of a user application intended to execute on data processing array 102. Application 304 may be specified as a DFG including a plurality of kernels. Compiler 302 generates a compiled version of application 304 (not shown) and is also capable of generating graph configuration 306. Graph configuration 306 includes data specifying information about the implementation of the compiled version of application 304 with respect to data processing array 102. As an example, graph configuration 306 may specify information such as a mapping of kernels of application 304 to tiles of data processing array 102, a mapping of data flows of application 304 to physical data paths of data processing array 102, particular interfaces and/or components used in different tiles of data processing array 102 that implement the data flows, and data transfer operations (e.g., read and/or write operations) performed by the kernels of application 304.

In the example of FIG. 3, framework 300 includes an input/output (IO) data flow detector 308, an IO dependency evaluator 310, and an IO software test (IO-ST) builder 312. A software test (ST) library 314 also may be included.

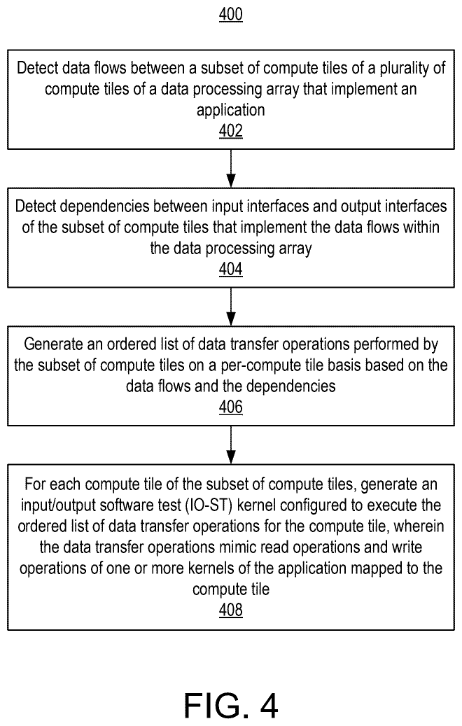

FIG. 4 illustrates an example method 400 of generating a functional safety testing application as performed by framework 300 of FIG. 3. Referring to FIGS. 3 and 4 in combination, in block 402, framework 300 is capable of detecting data flows between a subset of compute tiles of a plurality of compute tiles of data processing array 102 that implement application 304. For example, IO data flow detector 308 is capable of detecting each data flow specified in graph configuration 306. Each data flow is implemented or conducted over a data path of data processing array 102 by virtue of being assigned or mapped to particular hardware components in data processing array 102.

In block 402, IO data flow detector 308 is capable of detecting the data flows of application 304 by parsing graph configuration 306. For example, IO data flow detector 308 is capable of extracting each data flow for application 304 from graph configuration 306. As an example, a data flow, as extracted from graph configuration 306, may specify a source kernel as mapped to a compute tile, a destination compute tile, and the interfaces (e.g., physical interface circuits) used to effectuate the data flow. The interfaces may include a write interface of the source/destination compute tile and a read interface of the source/destination compute tile. This information specifies not only the data flow, but the data path in reference to the physical circuitry used to implement the data flow for data processing array 102.

The data flows that are detected in block 402 are between a subset of compute tiles 112 of the plurality of compute tiles (e.g., the total number of compute tiles 112 or available compute tiles 112) of data processing array 102 as application 304 will utilize fewer compute tiles 112 than the total number of compute tiles available. The particular compute tiles 112 used by application 304 may be detected based on the mapping of kernels to compute tiles specified by graph configuration 306. Only those compute tiles 112 having one or more kernels mapped or assigned thereto considered within the subset of compute tiles 112 used by application 304.

In block 404, framework 300 is capable of detecting dependencies between input interfaces and output interfaces of the subset of compute tiles 112 that implement the data flows for application 304 as compiled for implementation in data processing array 102. In block 404, IO dependency evaluator 310 is capable of detecting dependencies between the interfaces based on the data flows detected by IO data flow detector 308.

In block 406, framework 300 is capable of generating an ordered list of data transfer operations performed by the subset of compute tiles on a per-compute tile basis based on the data flows as extracted and the dependencies that have been determined. For example, for each compute tile used by application 304, IO dependency evaluator 310 is capable of generating an ordered list of the data transfer operations performed by the set of one or more kernels mapped to that compute tile.

In block 408, framework 300 and, more particularly, IO-ST builder 312, is capable of generating IO-ST kernels 316 configured to execute the ordered list of data transfer operations for the compute tiles. Each IO-ST kernel 316 is configured to mimic data transfer operations (e.g., data flows) performed by kernels of application 304 for a given compute tile. For example, for each compute tile of the subset of compute tiles used by application 304, IO-ST builder 312 is capable of generating an IO-ST kernel configured to execute the ordered list of data transfer operations for the compute tile. The data transfer operations performed or executed by the IO-ST kernel mimic the actual read operations and write operations of one or more kernels of application 304 (e.g., application kernels) mapped to the compute tile.

In one or more examples, IO-ST builder 312 is capable of building the IO-ST kernels 316 using ST library 314. The IO-ST kernels 316 may be generated as source code in any of a variety of different programming languages, e.g., C, C++, or the like, and compiled into executables. ST library 314 includes a variety of primitives that IO-ST builder may use to construct IO-ST kernels 316. These primitives may implement particular functions such as read stream data (read data received over a stream interconnect 126), write stream data (e.g., write data to a stream interconnect 126), write data to a cascade output, read data from a cascade input, write data to a shared memory, and/or read data from a shared memory. The functions implement the various data transfer operations to be performed by the IO-ST kernels 316.

As an illustrative and non-limiting example, consider the case where compute tile 112-10 has an application kernel mapped thereto. The IO-ST kernel generated for compute tile 112-10 will execute data transfer operations that mimic the actual data transfer operations performed by the application kernel. In the case where compute tile 112-10 has two or more application kernels mapped thereto, the IO-ST kernel generated for compute tile 112-10 will execute data transfer operations that mimic the actual data transfer operations, e.g., a union of the actual data transfer operations, performed by each of the two or more application kernels mapped to compute tile 112-10. Each IO-ST kernel may be implemented as a consolidation of the application kernels for a given compute tile to replicate usage of the same data interfaces used by the application kernels for the compute tile. Each data transfer operation mimicking a read operation and/or a write operation of an application kernel will also convey the same amount of data via the same interfaces to the same destinations. If the application kernels utilize 3 particular read (input) interfaces and 3 particular write (output) interfaces, the IO-ST kernel for that compute tile will implement data transfer operations, e.g., using test data, over these same 3 read interfaces and the same 3 write interfaces of the tile.

The collection of IO-ST kernels 316 generated by IO-ST builder 312 implements a data path functional safety testing application that is capable of testing each data path of data processing array 102 that is used by application 304. The examples of FIGS. 3 and 4 illustrate that IO-ST kernels 316 are generated and may convey data that is the same in terms of timing and quantity as the actual data transfer operations performed by the application kernels. The data conveyed, however, may be test data (e.g., having a dummy, arbitrary, or random payload portion) in that the IO-ST kernels 316 are not replicating the actual functions performed by the application kernels or the content of the data transfers, rather just the input/output behaviors.

For example, each IO-ST kernel of a compute tile of the subset of compute tiles is configured to receive test data on each input interface used by the one or more application kernels mapped to the selected compute tile and to output the test data on each output interface used by the one or more application kernels mapped to the selected compute tile.

In the examples of FIGS. 3 and 4, the data path configuration that programs components to implement the physical data paths within data processing array 102 need not be generated by framework 300. The data path configuration is already present in the compiled version of application 304 generated by compiler 302 and may be re-used with and/or by the IO-ST kernels 316 to realize the functional safety testing application.

As discussed, IO dependency evaluator 310 is capable of detecting dependencies between the input and output interfaces of all the tiles used by application 304 so that IO-ST builder 312 may create an IO-ST kernel 316 for each tile (e.g., each compute tile). IO dependency evaluator 310 resolves the corresponding read-write operation dependencies in such a way that there are no stalls or deadlocks at the level of data processing array 102. The IO-ST kernels 316 are not replicating functionality of the underlying application kernels, but are replicating the data transfer operations. IO dependency evaluator 310 resolves dependencies because the inner-logic and timing of the application kernels is not evaluated or reproduced by framework 300. Dependency resolution is necessary to avoid deadlocks in cases where the IO-ST kernels 316 perform the data transfer operations in an order that would result in a deadlock.

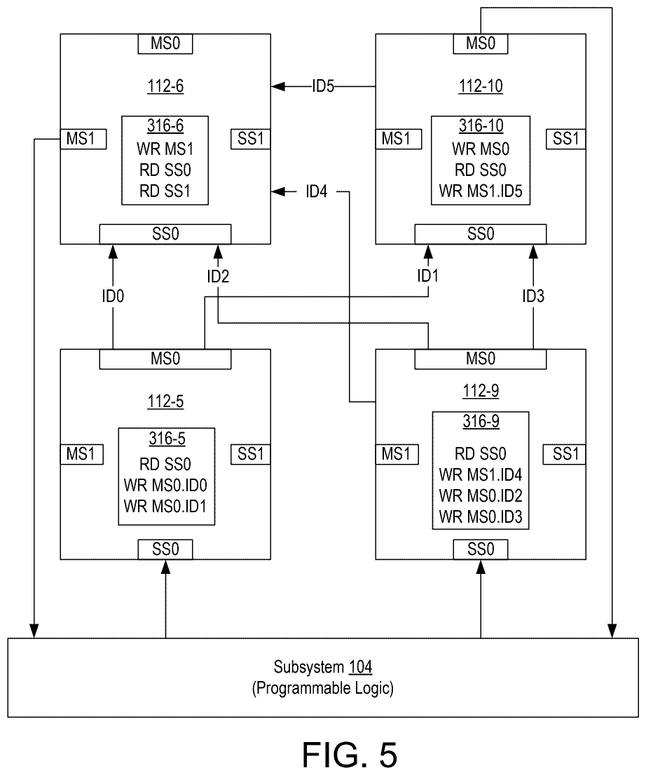

FIG. 5 illustrates an example deadlock condition that may occur in data processing array 102 due to the IO-ST kernels 316 in each respective compute tile 112 performing data transfer operations of application 304 in an incorrect, or deadlock inducing, order. In the example of FIG. 5, the order in which input and output interfaces are processed by the IO-ST kernels 316 at the individual tiles is incorrect. In the example, compute tiles 112-5, 112-6, 112-9, and 112-10 are shown each having a respective IO-ST kernel 316-5, 316-6, 316-9, and 316-10. Further, each compute tile includes write (output) interfaces MS0 and MS1 and read (input) interfaces SS0 and SS1. The ordered list of data transfer operations performed by each IO-ST kernel is shown in the respective IO-ST kernel using the nomenclature of “WR” for write or “RD” for read followed by the particular port. For example, “WR MS0.ID0” defines a write to output interface MS0 to convey data (e.g., a transaction) of ID0. Each data transfer operation can be presumed to be performed in a time slot corresponding to the ordering of the data transfer operation in the list. For example, the first transaction in each IO-ST kernel may be presumed to be performed first (at the same time or concurrently), followed by the second transaction in each list, etc.

At the time of performing functional safety testing of the data paths of data processing array 102 used by application 304, IO-ST kernels 316 are loaded into the respective compute tiles 112 of data processing array 102 and executed. Execution of the IO-ST kernels 316 may start on all compute tiles simultaneously. In the example of FIG. 5, each of the compute tiles (e.g., the cores 118 thereof) execute the first operation as there is no dependency.

The write transaction WR MS1.ID4, however, of compute tile 112-9 is stalled because the corresponding read operation RD SS1 of compute tile 112-6 is waiting for the read operation of RD SS0 therein to complete. The read operation RD SS0 of compute tile 112-6 is waiting for the data to be provided by write operation WR MS0.ID2 from compute tile 112-9 to complete. The write operation WR MS0.ID2 to be performed by compute tile 112-9 is pending due to the stalled write transaction WR MS1.ID4 therein. The example of FIG. 5 illustrates how incorrect ordering of operations in the IO-ST kernels 316 may result in a circular dependency between compute tiles 112-6 and 112-9 leading to a stall or deadlock condition in data processing array 102.

For purposes of illustration, Table 1 below provides the status of each data transfer operation for each of the compute tiles used by application 304 (e.g., the subset of compute tiles of data processing array 102) in FIG. 5.

TABLE 1

| Tile | Data transfer operation | Status |
|---|---|---|
| 112-6 | WR MS1 | Completed |
| 112-6 | RD SS0 | Partially complete |
| 112-6 | RD SS1 | Not processed |
| 112-10 | WR MS0 | Completed |
| 112-10 | RD SS0 | Partially complete |
| 112-10 | WR MS1.ID5 | Not processed |
| 112-5 | RD SS0 | Completed |
| 112-5 | WR MS0.ID0 | Completed |
| 112-5 | WR MS0.ID1 | Completed |
| 112-9 | RD SS0 | Completed |
| 112-9 | WR MS1.ID4 | Stalled |
| 112-9 | WR MS0.ID2 | Not processed |
| 112-9 | WR MS0.ID3 | Not processed |

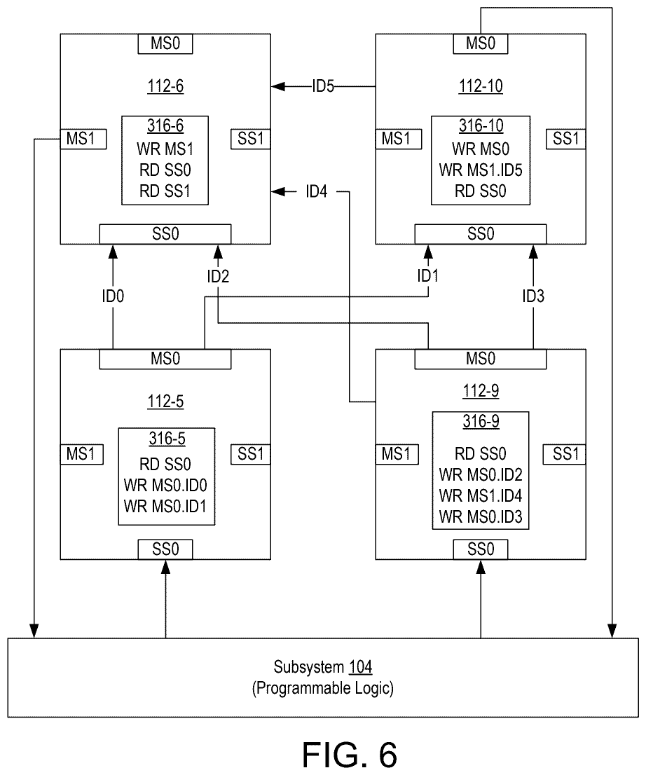

FIG. 6 illustrates an example in which the deadlock condition illustrated in FIG. 5 is resolved or avoided through operation of framework 300. In particular, IO dependency evaluator 310 is capable of performing operation ordering by identifying the correct order of read operations and write operations to/from interfaces of compute tiles accounting for all interface dependencies of the data flows. In the example, the ordering of data transfer operations in compute tile 112-10 and in compute tile 112-9 has been changed. Referring to compute tile 112-10, the initial order of operations in FIG. 5 was WR MS0, RD SS0, and WR MS1.ID5. FIG. 6 illustrates that the ordering is changed to WR MS0, WR MS1.ID5, and RD SS0. Referring to compute tile 112-9, the initial order of operations in FIG. 5 was RD SS0, WR MS1.ID4, WR MS0.ID2, and WR MS0.ID3. FIG. 6 illustrates that the ordering is changed to RD SS0, WR MS0.ID2, WR MS1.ID4, and WR MS0.ID3.

IO dependency evaluator 310, in performing blocks 404 and 406 of FIG. 4, is capable of parsing each input interface along with the data flow (and corresponding data path) to identify the corresponding output interface and generate the ordered list of data transfer operations for each IO-ST kernel 316. Appreciably, as there is a one-to-one correspondence between IO-ST kernels and compute tiles used by application 304, each ordered list of data transfer operations may be characterized as belonging to a particular IO-ST kernel or the particular compute tile to which that IO-ST kernel is mapped. In any case, based on the dependencies, IO-ST builder 312 is capable of generating a read-write instruction pair for the respective IO-ST kernels 316 involved on each end of the data transfer operation. For example, a read is added to the IO-ST kernel 316 (e.g., to the ordered list from which the IO-ST kernel is constructed) with the input interface and a write operation (e.g., a “corresponding” write operation) is added to a different IO-ST kernel 316 (e.g., to the ordered list from which the different IO-ST kernel is constructed) having the output interface.

In cases where an input interface is driven by multiple output interfaces (e.g., from multiple compute tiles 112), each output interface will have its own write operation added to the respective IO-ST kernel 316 for the compute tile including such an output interface. The same process may be repeated for the output interfaces of the compute tiles. In this manner, all of the interfaces of a compute tile may be back traced until the IO-ST kernel for that compute tile is generated covering all of the interfaces with proper ordering of the data transfer operations. This process may be repeated for all interfaces of all compute tiles used by the application until all of the IO STL kernels 316 are created.

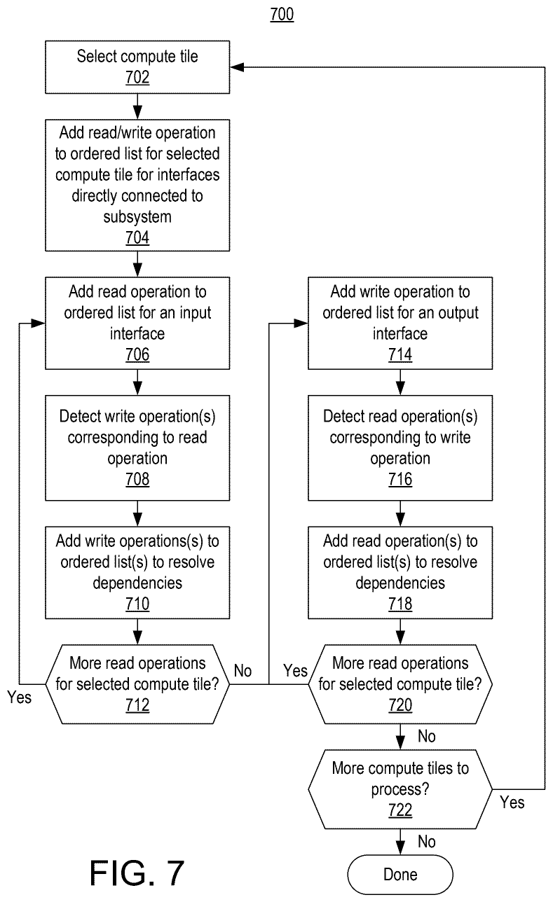

FIG. 7 illustrates an example method 700 of implementing blocks 404 and 406 of FIG. 4 as performed by IO dependency evaluator 310. In block 702, IO dependency evaluator 310 selects a compute tile that is used by application 304. In block 704, IO dependency evaluator 310 adds any read and/or write operations to the ordered list for the selected compute tile for any interfaces that are directly connected to a subsystem 104 (e.g., programmable logic in the example of FIGS. 5 and 6).

In block 706, IO dependency evaluator 310 adds a read operation to the ordered list for an input interface of the selected compute tile. In block 708, IO dependency evaluator 310 detects any write operations (e.g., one or more write operations) corresponding to the read operation from block 706. The corresponding write operations are the write operations initiated in other compute tiles that provide the data that is being read by the read operation of block 706.

In block 710, IO dependency evaluator 310 adds a write operation to the ordered list for each compute tile identified in block 708. In block 712, IO dependency evaluator 310 determines whether there are any further read operations for the selected compute tile to be processed. In response to determining that one or more read operations remain to be processed for the selected compute tile, method 700 loops back to block 706 to process further read operations. In response to determining that no further read operations remain to be processed for the selected compute tile, method 700 continues to block 714.

In block 714, IO dependency evaluator 310 adds a write operation to the ordered list an output interface of the selected compute tile. In block 716, IO dependency evaluator 310 detects any read operations (e.g., one or more read operations) corresponding to the write operation from block 714. The corresponding read operations are the read operations initiated in other compute tiles that receive the data that is being written by the write operation of block 714.

In block 718, IO dependency evaluator 310 adds a read operation to the ordered list for each compute tile identified in block 716. In block 720, IO dependency evaluator 310 determines whether there are any further write operations for the selected compute tile to be processed. In response to determining that one or more write operations remain to be processed for the selected compute tile, method 700 loops back to block 714 to process further write operation write operations. In response to determining that no further write operations remain to be processed for the selected compute tile, method 700 continues to block 722.

In block 722, IO dependency evaluator 310 determines whether there are any further compute tiles of application 304 that remain to be processed. In response to determining that one or more compute tiles used by application 304 (e.g., one or more of the subset of compute tiles) remain to be processed, method 700 loops back to block 702 to process further compute tiles. In response to determining that no further compute tiles used by application 304 remain to be processed, method 700 may end.

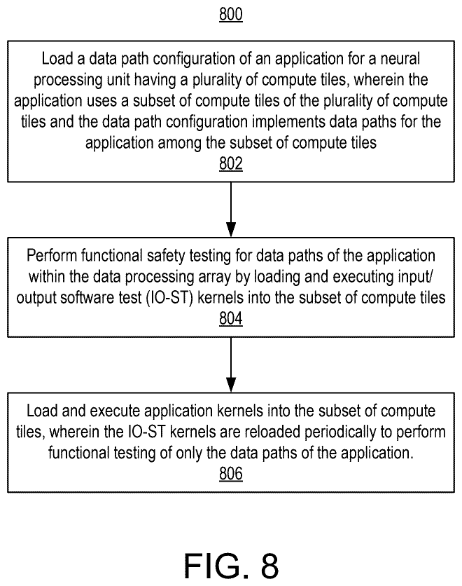

FIG. 8 illustrates an example method 800 of performing functional safety testing of data paths of data processing array 102. Method 800 may begin in a state where application 304 has been compiled. The compiled application includes compiled application kernels and a data path configuration that implements the data paths of application 304 within data processing array 102. Further, an IO-ST kernel 316 for each compute tile 112 used by application 304 has been generated. In this regard, method 800 illustrates a runtime method where functional safety testing may be performed periodically (e.g., at predetermined time intervals) during operation of data processing array 102.

In block 802, the data path configuration for application 304 is loaded into data processing array 102. As discussed, application 304, as compiled, uses a subset of compute tiles (e.g., only selected compute tiles) of the plurality of compute tiles of data processing array 102. The data path configuration implements the data paths for application 304 among the subset of compute tiles.

In block 804, functional safety testing of the data paths of the application within data processing array 102 of (e.g., used by) is performed. For example, in block 804, the IO-ST kernels 316 may be loaded into the subset of compute tiles of data processing array 102 and executed. In executing IO-ST kernels 316, which are mapped to particular compute tiles, each IO-ST kernel 316 beings executing the ordered list of data transfer operations therein effectively testing the data paths of data processing array 102 used by application 304. By execution of IO-ST kernels 316, only those data paths of data processing array 102 used by application 304 are tested.

In block 806, the application kernels may be loaded into the subset of compute tiles and executed. In this regard, the IO-ST kernels 316 may be reloaded periodically or from time-to-time to perform functional safety testing of the data paths of data processing array 102 used by application 304. For example, the IO-ST kernels and the application kernels may be alternatingly loaded and executed while the data paths specified by the data path configuration are maintained intact.

For example, during functional safety testing, any given IO-ST kernel of a selected compute tile is capable of receiving test data on each input interface used by one or more of the application kernels mapped to same selected compute tile and output the test data on each output interface used by the one or more application kernels mapped to the that selected compute tile.

In executing, each IO-ST kernel 316 executing in a given compute tile expects pre-defined test data having an embedded checksum on each of the input interfaces of the compute tile 112 that are used by the application kernels mapped to that same compute tile. That IO-ST kernel is capable of sending out the same test data on each of the output interfaces of the compute tile 112 used by the application kernels mapped to that same compute tile.

In response to receiving test data on an input interface, the IO-ST kernel is capable of calculating a checksum of the test data. The IO-ST kernel is further capable of comparing the checksum as calculated with the embedded checksum of the test data to detect whether the two match. Any mismatch detected by the IO-ST kernel between the embedded checksum and the calculated checksum causes the IO-ST kernel to generate or trigger an error.

In one or more examples, in cases where no mismatches are detected for all input interfaces of a given compute tile, the IO-ST kernel therein is capable of sending out the same test data on all the output interfaces. For example, the sending of data via the output interfaces by an IO-ST kernel may be predicated, or depend on, detecting no checksum mismatches on received test data. Any IO-ST kernels that receive test data sent from another IO-ST kernel may perform the same validation by calculating the checksum and comparing the calculated checksum with the embedded checksum in the received test data.

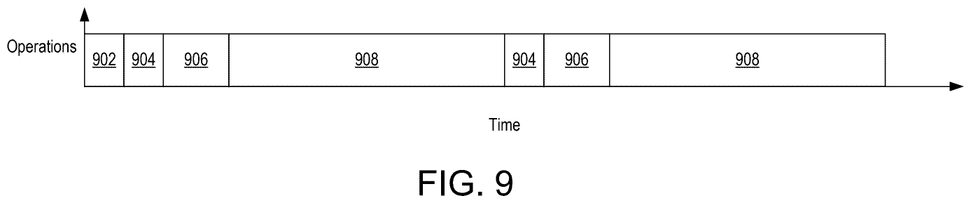

FIG. 9 illustrates a timing diagram for performing functional safety testing of data paths of data processing array 102 using the example implementations described herein. The example illustrates an iterative process in which only those data paths used by an application executing in data processing array 102 may be tested periodically during runtime without requiring too much time. That is, the amount of time allocated for functional safety testing of the data paths, as opposed to executing the application, is reduced or minimized.

In the example, each of blocks 902, 904, 906, and 908 represents a portion or window of time during which particular functions/operations are performed. In block 902, for example, the data path configuration of application 304 is loaded into IC device 100 (e.g., into data processing array 102). For example, data processing array 102 may include configuration registers of the respective components being configured that may be written with the configuration data of data path configuration. Though not discussed, tiles of data processing array 102 may include memory mapped interfaces allowing such configuration data to be written to configuration registers. The data path configuration, once loaded, implements the data paths that are used by application 304 as compiled. The data path configuration, as noted, may program the read interfaces and write interfaces of tiles of data processing array 102 (e.g., components such as stream interconnects, DMA circuits, cascade interfaces, and shared memory interfaces).

In block 904, the IO-ST kernels 316 are loaded into data processing array 102 and executed to perform functional safety testing. The IO-ST kernels 316 are loaded into the particular compute tiles used by application 304 and execute to perform functional safety testing of only those data paths used by application 304. In block 906, core hardware testing may be performed by loading CORE-ST kernels into the particular compute tiles used by application 304. The CORE-ST kernels may be executed to perform functional safety testing of the cores 118 themselves. That is, while IO-ST kernels perform software testing of data paths, the CORE-ST kernels are configured to perform software testing of cores 118 and the various functions performed by cores 118. Such testing may be performed as part of the functional testing described herein.

In block 908, the application kernels are loaded into data processing array 102 and may be executed. The application kernels are loaded into those compute tiles used by application 304. The process may repeated at predetermined intervals, e.g., every 100 milliseconds. Both application kernels and IO-ST kernels may be written (e.g., loaded) into the respective program memories 120 of the relevant compute tiles 112 by way of the memory mapped interfaces implemented in data processing array 102.

In the example, more time is available for executing application 304 despite any requirements to perform functional safety testing of data paths every N milliseconds (e.g., where N=100 in this example). The value of N may be different depending on the particular functional safety requirements to be met. Because the same data path configuration is used by both application 304 and the IO-ST kernels 316, the only time needed to switch over between executing application kernels and executing IO-ST kernels 316 is the time to load each type of kernel into the respective program memories 120. The data path configuration need not be reloaded, which is illustrated in FIG. 9 in that block 902 occurs one time and need not be repeated for subsequent functional safety testing. If, for example, one were to try to test all data paths of data processing array 102, such testing would require a large quantity of test-specific data path configuration data that would need to be loaded requiring significantly more time than illustrated in the example of FIG. 9.

In the example of FIG. 9, the actual test time required for loading and executing the IO-ST kernels 316 is reduced owing to the reduced number of data paths to be tested. Again, were one to test all available data paths of data processing array 102, such testing would likely require multiple iterations of loading a first test-specific data path configuration followed by a first set of IO-ST kernels to test a first set of data paths, second test-specific data path configuration followed by a second set of IO-ST kernels to test a second set of data paths, etc., repeating until all data paths are tested. This leaves significantly less time for execution of application 304 given the requirement for performing periodic functional safety testing at predetermined time intervals (e.g., the size of window 908 would shrink).

Further, in reverting or switching from the functional safety testing to application 304 (loading application kernels), only the application kernels need to be reloaded. The data path configuration remains unchanged while the functional safety testing (loading and execution of IO-ST kernels and/or CORE-ST kernels as the case may be) and the application (loading and executing of application kernels) continue cycling through iterations. Such is the case because only those data paths used by the application require functional safety testing and may remain intact throughout both functional safety testing and execution of the application. Thus, the time to load the functional safety testing application and the user's application are reduced leaving more clock cycles available execution of the user's application.

Another benefit of the functional safety testing approach described within this disclosure is reduced power consumption by virtue of testing fewer data paths. In addition, as the functional safety testing is tailored to the particular application implemented in data processing array 102, any faults that may exist on unused data paths have no impact on operation of IC device 100 and/or data processing array 102.

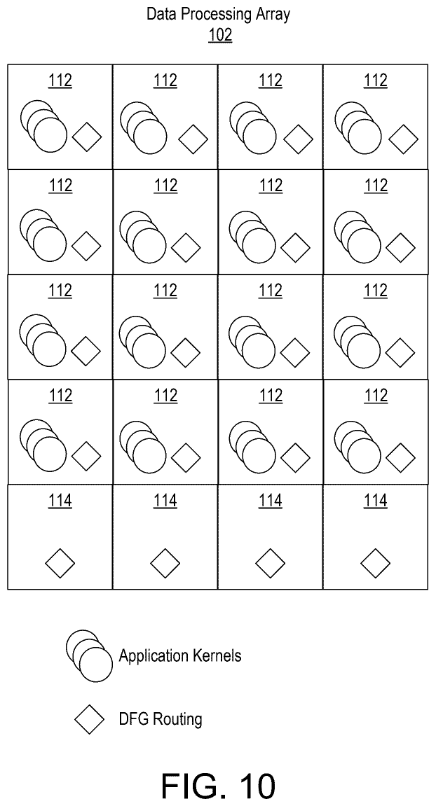

FIG. 10 illustrates an example of data processing array 102 executing application 304. For purposes of illustration, data processing array 102 is illustrated in a simplified form and memory tiles 116 have been omitted. In the example, each compute tile 112 is loaded with one or more application kernels in the program memory 120 of that respective compute tile. Further, the data path configuration implements the DFG routing shown.

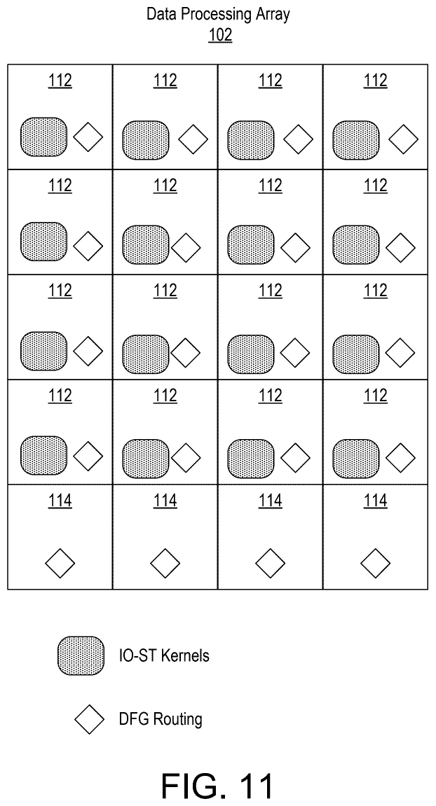

FIG. 11 illustrates an example of data processing array 102 executing the functional safety testing application. Again, for purposes of illustration, 102/is shown in a simplified form. In any case, in the example of FIG. 11, each compute tile 112 is loaded with an IO-ST kernel in the program memory 120 of that compute tile. As illustrated, the data path configuration remains intact or unchanged.

The examples of FIGS. 10 and 11 illustrate that the IO-ST kernel of a given compute unit is implemented to mimic a consolidation of the various data transfers performed by the application kernels of application 304 mapped to the same compute tile. During operation (e.g., at runtime of application 304 where functional safety testing is required at predetermined intervals), the state of data processing array 102 may be switched to that of FIG. 11 to perform functional safety testing. Once the functional safety testing is complete, the state of data processing array 102 may revert back to that of FIG. 10 to resume operation of application 304. This may continue to iterate depending on the frequency with which functional safety testing is to be performed.

FIG. 12 illustrates an example of a data processing system 1200. As used herein, the term “data processing system” refers to one or more hardware systems capable of processing data. Each hardware system may include one or more hardware processors and memory.

Data processing system 1200 includes a hardware processor 1202. Hardware processor 1202 may be implemented as one or more hardware processors. Hardware processor 1202 may be implemented as one or more circuits capable of executing computer-readable program instructions (program instructions). The circuit(s) may comprise integrated circuits (ICs) or may be embedded within an IC. In one or more examples, hardware processor 1202 may be embodied as a central processing unit (CPU). Hardware processor 1202 may include one or more cores, for example, where each core is capable of executing computer-readable program instructions. Hardware processor 1202 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

Data processing system 1200 can include memory 1204. Memory 1204 may be embodied as one or more computer-readable storage mediums. Memory 1204 may include a volatile memory 1206 and a non-volatile memory 1208. Volatile memory 1206 may be embodied as random-access memory (RAM) and may include cache memory. Volatile memory 1206 may be referred to as “runtime memory.” Non-volatile memory 1208 may include a non-volatile magnetic medium and/or a solid-state medium (typically called a “hard drive”). Non-volatile memory 1208 also may include one or more disk drives capable of reading from and writing to various types of removable, non-volatile mediums such as a removable, non-volatile magnetic disk (e.g., a “floppy disk”) and/or a removable, non-volatile optical disk such as a CD-ROM, DVD-ROM or other optical media.

Memory 1204 is capable of storing program instructions and/or data such that hardware processor 1202 is capable of executing the program instructions to perform one or more operations as described within this disclosure. For example, the program instructions can include an operating system, one or more application programs, other program code, and program data. The program instructions may implement framework 300, for example. Hardware processor 1202, in executing the computer-readable program instructions, is capable of performing the various operations described herein that are attributable to a computer.

Data processing system 1200 may include one or more Input/Output (I/O) interfaces 1210. I/O interface(s) 1210 allow data processing system 1200 to communicate with one or more external devices and/or communicate over one or more networks such as a local area network (LAN), a wide area network (WAN), and/or a public network (e.g., the Internet). Examples of I/O interfaces 1210 may include, but are not limited to, network cards, modems, network adapters (wired and/or wireless), hardware controllers, etc. Examples of external devices also may include devices that allow a user to interact with data processing system 1200 (e.g., a display, a keyboard, and/or a pointing device) and/or other devices such as an accelerator card and/or IC device 100.

Bus 1212 represents one or more of any of a variety of communication bus structures. By way of example, and not limitation, bus 1212 may be implemented as a Peripheral Component Interconnect Express (PCIe) bus. Bus 1212 couples to each of hardware processor 1202, memory 1204, and I/O interface(s) 1210 through respective interface circuitry thereby allowing the devices to communicate. Bus 1212 may represent a plurality of buses that may be interconnected and/or hierarchically organized.

Data processing system 1200 is only one example implementation. Data processing system 1200 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 12 is not intended to suggest any limitation as to the scope of use or functionality of example implementations described herein. Data processing system 1200 is an example of computer hardware that is capable of performing the various operations described within this disclosure. In this regard, data processing system 1200 may include fewer components than shown or additional components not illustrated in FIG. 12 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular examples only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, “data processing system” means one or more hardware systems configured to process data, each hardware system including at least one hardware processor programmed to initiate operations and memory.

As defined herein, the terms “in response to” and “responsive to” mean responding or reacting readily to an action or event. Thus, if a second action is performed “in response to” or “responsive to” a first action, there is a causal relationship between an occurrence of the first action and an occurrence of the second action. The term “responsive to” indicates the causal relationship. In some cases, other terms such as “if,” “when,” or “upon” are used and also convey a causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the term “real time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc., may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the implementations described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the implementations described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the implementations described herein.

Certain aspects of the implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the implementations. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various implementations of the disclosed technology have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method, comprising:
detecting data flows between a subset of compute tiles of a plurality of compute tiles of a data processing array that implement an application;
detecting dependencies between input interfaces and output interfaces of the subset of compute tiles that implement the data flows within the data processing array;
generating an ordered list of data transfer operations performed by the subset of compute tiles on a per-compute tile basis based on the data flows and the dependencies; and
for each compute tile of the subset of compute tiles, generating an input/output software test (IO-ST) kernel configured to execute the ordered list of data transfer operations for the compute tile to mimic read operations and write operations of one or more application kernels of the application mapped to the compute tile.

2. The method of claim 1, wherein the ordered lists for the subset of compute tiles avoid deadlocks as executed by the IO-ST kernels.

3. The method of claim 1, wherein the IO-ST kernel of a selected compute tile of the subset of compute tiles is configured to receive test data on each input interface used by the one or more application kernels mapped to the selected compute tile and output the test data on each output interface used by the one or more application kernels mapped to the selected compute tile.

4. The method of claim 1, wherein the IO-ST kernels are configured to implement functional safety testing by testing only a subset of data paths of available data paths of the data processing array that are used by the application to perform the data flows.

5. The method of claim 1, wherein the application maps one or more application kernels to each compute tile of the subset of compute tiles and the application kernels communicate via the data flows.

6. The method of claim 5, wherein, for each compute tile of the subset of compute tiles, the ordered list of data transfer operations conveys test data and corresponds to a union of read operations and write operations performed by each application kernel mapped to the compute tile.

7. The method of claim 6, wherein each IO-ST kernel implements each data transfer operation using a same input interface as the read operation being mimicked by the data transfer operation and a same write interface as the write operation being mimicked by the data transfer operation.

8. The method of claim 1, wherein the generating an ordered list of operations comprises:
for each compute tile of the subset having one or more application kernels mapped thereto that perform a read operation, adding the read operation to the list of the compute tile and adding a corresponding write operation to a list of another compute tile of the subset having one or more application kernels mapped thereto that perform the corresponding write operation.

9. The method of claim 1, wherein the generating an ordered list of operations comprises:
for each compute tile of the subset having one or more application kernels mapped thereto that perform a write operation, adding the write operation to the list of the compute tile and adding a corresponding read operation to a list of another compute tile having one or more application kernels mapped thereto that perform the corresponding read operation.

10. A method, comprising:
loading a data path configuration of an application into a data processing array having a plurality of compute tiles, wherein the application uses a subset of the plurality of compute tiles and the data path configuration implements data paths for the application among the subset of compute tiles;
testing the data paths of the application within the data processing array by loading and executing input/output software test (IO-ST) kernels into the subset of compute tiles, wherein the data paths are a subset of available data paths of the data processing array used by the application; and
loading and executing application kernels into the subset of compute tiles.

11. The method of claim 10, wherein the IO-ST kernels and the application kernels are alternatingly loaded and executed while the data paths specified by the data path configuration are maintained intact.

12. The method of claim 10, further comprising:
iteratively performing the testing the data paths and the loading and executing application kernels to test the data paths at predefined time intervals.

13. The method of claim 10, wherein the IO-ST kernels are configured to mimic data flows of the application using the data paths.

14. The method of claim 13, wherein the IO-ST kernel of a selected compute tile of the subset is configured to receive test data on each input interface used by one or more of the application kernels mapped to the selected compute tile and output the test data on each output interface used by the one or more application kernels mapped to the selected compute tile.

15. The method of claim 14, wherein the test data includes an embedded checksum, the method further comprising:
the IO-ST kernel calculating a checksum for the test data;
the IO-ST kernel comparing the checksum as calculated with the embedded checksum; and
in response to detecting a mismatch between the checksum as calculated and the embedded checksum, the IO-ST kernel generating an error.

16. An integrated circuit device, comprising:
a data processing array having a plurality of compute tiles, wherein each compute tile includes a plurality of interfaces;
wherein a subset of compute tiles of the plurality of compute tiles are selected to implement an application;
wherein the data processing array implements data paths of the application between the subset of compute tiles using selected interfaces of the plurality of interfaces of the subset of compute tiles; and
wherein the subset of compute tiles alternatingly implement the application having one or more application kernels mapped to the subset of compute tiles and input/output software test (IO-ST) kernels mapped to the subset of compute tiles to perform functional safety testing of the data paths of the application.

17. The integrated circuit device of claim 16, wherein, for each compute tile of the subset, the IO-ST kernel mapped to the compute tile mimics data flows of one or more of the application kernels mapped to the compute tile over the data paths used by the compute tile.

18. The integrated circuit device of claim 17, wherein the IO-ST kernel of a selected compute tile of the subset is configured to receive test data on each input interface used by the one or more application kernels mapped to the selected compute tile and output the test data on each output interface used by the one or more application kernels mapped to the selected compute tile.

19. The integrated circuit of claim 18, wherein the test data includes an embedded checksum; and
wherein the IO-ST kernel is configured to calculate a checksum of the test data, compare the checksum as calculated with the embedded checksum, and, in response to detecting a mismatch between the checksum as calculated and the embedded checksum, generate an error.

20. The integrated circuit device of claim 16, wherein the IO-ST kernels implement functional safety testing of the data paths, wherein the data paths are a subset of available data paths of the data processing array.
